(19) United States
(12) Patent Application Publication
(10) Pub. No.: US 2011/0180478 A1
(43) Pub. Date: Jul. 28, 2011

(54) FILTRATION SYSTEMS AND METHODS RELATED THERETO USING CARBON NANOTUBE-INFUSED FIBER MATERIALS OF SPOOLABLE LENGTH AS A MOVING FILTRATION MEDIUM

(75) Inventors: Tushar K. SHAH, Columbia, MD (US); Harry C. MALECKI, Abingdon, MD (US)

(73) Assignee: APPLIED NANOSTRUCTURED SOLUTIONS, LLC, Baltimore, MD (US)

(21) Appl. No.: 13/011,826

(22) Filed: Jan. 21, 2011

Related U.S. Application Data
(60) Provisional application No. 61/297,704, filed on Jan. 22, 2010.

(51) Int. Cl. B01D 15/10; B01D 36/00; B01D 33/052; B01D 39/00; C02F 1/28; C02F 1/40; B01D 15/08; B01D 11/04; B82Y 30/00

(52) U.S. Cl. 210/638; 210/502.1; 210/483; 210/499; 210/496; 210/491; 210/400; 210/401; 210/386; 210/259; 210/679; 210/680; 210/676; 977/742; 977/902

(57) ABSTRACT

Filtration systems containing a filtration medium and methods related thereto are described herein. The filtration system includes a plurality of fibers of spoolable length, where the fibers are a carbon nanotube-infused fiber material. The filtration systems can be operated with reel-to-reel processing or in a continuous manner in order to sorb hydrophobic materials from a liquid medium. The filtration systems also include various means to remove the hydrophobic materials from the filtration medium, including press rollers and chemical extraction baths. Illustrative liquid media that can be treated with the filtration systems include, for example, hydrophobic materials admixed in an aqueous phase, bilayers (e.g., oil-water bilayers), oil in a subterranean formation, water sources containing trace organic pollutants or trace organic compounds, and fermentation broths.

### CROSS-REFERENCE TO RELATED APPLICATIONS

This application claims the benefit of priority under 35 U.S.C. §119 from U.S. Provisional Patent Application Ser. No. 61/297,704, filed Jan. 22, 2010, which is incorporated herein by reference in its entirety. This application is also related to U.S. patent application Ser. Nos. 12/611,073, 12/611,101 and 12/611,103, all filed on Nov. 2, 2009.

### STATEMENT REGARDING FEDERALLY SPONSORED RESEARCH OR DEVELOPMENT

Not applicable.

### FIELD OF THE INVENTION

The present invention generally relates to filtration and, more specifically, to filtration using carbon nanotubes.

### BACKGROUND

The ability to remove hydrophobic materials (e.g., oil and like petrochemicals, environmental pollutants, trace substances, solvents, and like hydrophobic organic compounds) from various liquid media is a feature of a variety of applications including, for example, oil extraction and separation, environmental remediation, water purification, hazardous materials cleanup, and isolation/purification of trace organic compounds. Typical sorption materials that are used for the removal of hydrophobic materials from liquid media are themselves hydrophobic compounds having an affinity for other hydrophobic compounds.

The effectiveness of a material for sorbing hydrophobic materials is typically expressed as the ratio of the sorbed mass of hydrophobic material to a given mass of sorption material. This ratio is referred to herein as the sorption capacity. Conventional sorption materials used for removing hydrophobic materials from a liquid medium often exhibit sorption capacities of about 20 or lower. That is, the sorption materials are capable of sorbing an amount of hydrophobic material that is up to about 20 times the mass of the sorption material. Most conventional sorption materials are utilized in a batch manner, rather than in continuous or near-continuous processes.

Due to their hydrophobic character, carbon nanotubes are capable of sorbing large quantities of hydrophobic materials per unit mass. It has been reported that carbon nanotubes can sorb up to about 180 times their weight of certain hydrophobic materials. In spite of the high sorption capacity of carbon nanotubes, high production costs have impeded their commercial development for most applications, including those involving removal of hydrophobic materials from liquid media. Like more conventional sorption materials, carbon nanotubes have heretofore only been utilized in a batch manner for sorption of hydrophobic materials.

In view of the foregoing, new sorption materials having high sorption capacities for hydrophobic materials would be of substantial benefit in the art. Such sorption materials can be used in various filtration processes for removal and isolation of hydrophobic materials from liquid media. Ideally, processes for making these sorption materials would be capable of being carried out on a scale sufficient to enable their widespread utilization at low cost in various applications requiring the removal of hydrophobic materials from liquid media. In addition, the ability to utilize these sorption materials in continuous or near-continuous processes would greatly facilitate their ease of use and improve the speed at which hydrophobic materials can be removed from various liquid media. The present invention directly satisfies these needs and provides related advantages as well.

### SUMMARY

In some embodiments, filtration systems described herein include a moving filtration medium containing a plurality of fibers of spoolable length, where the fibers are a carbon nanotube-infused fiber material.

In some embodiments, filtration systems described herein include a reel-to-reel processing system containing a first reel and a second reel, a moving filtration medium connected to the reel-to-reel processing system, at least one alignment roller and at least one dip roller against which the moving filtration medium is tensioned, and at least one press roller through which the moving filtration medium is transported. The moving filtration medium contains a plurality of fibers of continuous length, where the fibers are a carbon nanotube-infused fiber material.

In some embodiments, methods described herein include providing a moving filtration medium containing a plurality of fibers of spoolable length, where the fibers are a carbon nanotube-infused fiber material; transporting the moving filtration medium through a liquid medium containing a hydrophobic material; sorbing at least a portion of the hydrophobic material from the liquid medium onto the moving filtration medium; and transporting the moving filtration medium through at least one press roller after sorbing the hydrophobic material.

In some embodiments, methods described herein include providing a moving filtration medium containing a plurality of fibers of spoolable length that is connected to a reel-to-reel processing system containing a first reel and a second reel, where the fibers are a carbon nanotube-infused fiber material; transporting the moving filtration medium through a liquid medium containing a hydrophobic material; sorbing at least a portion of the hydrophobic material from the liquid medium onto the moving filtration medium; transporting the moving filtration medium through at least one press roller after sorbing the hydrophobic material; and sequestering any hydrophobic material removed at the at least one press roller in a collection device.

In some embodiments, methods described herein include providing a moving filtration medium containing a plurality of fibers of spoolable length, where the fibers are a carbon nanotube-infused fiber material; transporting the moving filtration medium through a liquid medium containing a trace hydrophobic compound; sorbing at least a portion of the trace hydrophobic compound from the liquid medium onto the moving filtration medium; and isolating the trace hydrophobic compound from the moving filtration medium.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing a specific embodiments of the disclosure, wherein:

FIG. 1 shows an illustrative TEM image of carbon nanotubes that have been infused to carbon fibers;

FIG. 2 shows an illustrative SEM image of a carbon fiber that has been infused with carbon nanotubes, where the carbon nanotubes are within ±20% of a targeted length of 40 μm;

FIG. 3 shows a schematic of an illustrative embodiment of a filtration system containing a reel-to-reel processing system for a carbon nanotube-infused fiber material moving filtration medium;

FIG. 4 shows a schematic of an alternative illustrative embodiment of a filtration system containing a reel-to-reel processing system for a carbon nanotube-infused fiber material moving filtration medium;

FIG. 5 shows a schematic of an illustrative filtration system containing a continuous loop of a carbon nanotube-infused fiber material moving filtration medium; and

FIG. 6 shows an illustrative SEM image of a fabric weave of carbon nanotube-infused carbon fibers.

### DETAILED DESCRIPTION

The present disclosure is directed, in part, to filtration systems containing a moving filtration medium, where the moving filtration medium contains a plurality of fibers of spoolable length. The present disclosure is also directed, in part, to filtration methods and trace compound isolation methods utilizing a moving filtration medium, where the moving filtration medium contains a plurality of fibers of spoolable length. According to the embodiments herein, the fibers of spoolable length are a carbon nanotube-infused fiber material.

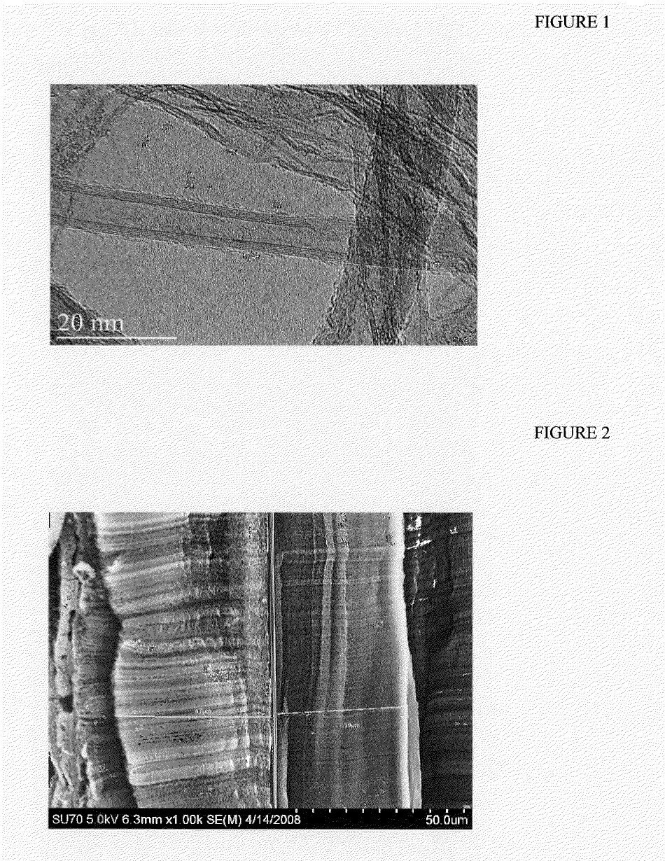

Fiber materials that have been infused with carbon nanotubes, including carbon fibers, ceramic fibers, metal fibers, glass fibers, and organic fibers (e.g., aramid fibers) are described in Applicants' co-pending U.S. patent application Ser. Nos. 12/611,073, 12/611,101, and 12/611,103, all filed on Nov. 2, 2009, and 12/938,328, filed on Nov. 2, 2010, each of which is incorporated herein by reference in its entirety. FIG. 1 shows an illustrative TEM image of carbon nanotubes that have been infused to carbon fibers. FIG. 2 shows an illustrative SEM image of a carbon fiber that has been infused with carbon nanotubes, where the carbon nanotubes are within ±20% of a targeted length of 40 μm. In the images of FIGS. 1 and 2, the carbon nanotubes are multi-wall carbon nanotubes, although any type of carbon nanotube such as single-wall carbon nanotubes, double-wall carbon nanotubes, and multi-wall carbon nanotubes having more than two walls can be used in the various embodiments herein.

As used herein, the term “infused” refers to being bonded, and “infusion” refers to the process of bonding. As such, a carbon nanotube-infused fiber material refers to a fiber material that has carbon nanotubes bonded thereto. Such bonding of carbon nanotubes to a fiber material can involve mechanical attachment, covalent bonding, ionic bonding, pi-pi interactions, and/or van der Waals force-mediated physisorption. In some embodiments, the carbon nanotubes are directly bonded to the fiber material. In other embodiments, the carbon nanotubes are indirectly bonded to the fiber material via a barrier coating and/or a catalytic nanoparticle used to mediate growth of the carbon nanotubes. The particular manner in which the carbon nanotubes are infused to the fiber material can be referred to as the bonding motif.

As used herein, the terms “spoolable lengths” or “spoolable dimensions” equivalently refer to a fiber material that has at least one dimension that is not limited in length, thereby allowing the fiber material to be stored on a spool or mandrel following infusion with carbon nanotubes. A fiber material of “spoolable lengths” or “spoolable dimensions” have at least one dimension that indicates the use of either batch or continuous processing for carbon nanotube infusion to the fiber material.

In addition, carbon nanotube-infused fiber materials of “spoolable lengths” or “spoolable dimensions” can be used in the various continuous or near-continuous filtration systems and methods described herein. In general, a carbon nanotube-infused fiber material of the present disclosure is of a spoolable length if the fiber material is greater than about 1.5 feet in length. In some embodiments herein, carbon nanotube-infused fiber materials of spoolable length are greater than about 100 feet in length. In other embodiments, carbon nanotube-infused fiber materials of spoolable length are greater than about 1,000 feet in length. In still other embodiments, carbon nanotube-infused fiber materials of spoolable length are greater than about 10,000 feet in length or greater than about 25,000 feet in length.

As used herein, the term “continuous” refers to a process that operates in an uninterrupted manner.

As used herein, the term “near-continuous” refers to a process that operates in a substantially uninterrupted manner. That is, the process operates in a continuous manner for at least a majority of the process time, with only minimal interruption needed for process maintenance.

As used herein, the terms “sorption,” “sorb,” “sorbing” and derivatives thereof refer to the physical processes of absorption and adsorption.

As used herein, the terms “transport,” “transporting,” and derivatives thereof refer to the process of being translocated from a first location to a second location.

As used herein, the term “hydrophobic” refers to materials that are substantially insoluble in water. However, in small quantities a hydrophobic material can be admixed with or slightly soluble in water or other aqueous media so as to give the appearance of being dissolved.

As used herein, the term “oil” generally refers to petroleum products including crude oil, refined oil, gasoline, diesel and like petroleum derivatives.

As used herein, the term “nanoparticle” refers to particles having a diameter between about 0.1 nm and about 100 nm in equivalent spherical diameter, although nanoparticles need not necessarily be spherical in shape.

As used herein, the terms “sizing agent,” “sizing material” or “sizing,” collectively refer to materials used in the manufacture of fiber materials as a coating to protect the integrity of the fiber material, to provide enhanced interfacial interactions with the fiber material, and/or to alter and/or to enhance certain physical properties of the fiber material.

As used herein, the term “transition metal” refers to any element or alloy of elements in the d-block of the periodic table (Groups 3 through 12), and the term “transition metal salt” refers to any transition metal compound such as, for example, transition metal oxides, carbides, nitrides, and the like. Illustrative transition metal catalytic nanoparticles suitable for infusing carbon nanotubes to fiber materials include, for example, Ni, Fe, Co, Mo, Cu, Pt, Au, Ag, alloys thereof, salts thereof, and mixtures thereof.

As used herein, the term “uniform in length” refers to a condition in which carbon nanotubes infused to a fiber material have lengths with tolerances of plus or minus about 20% or less of the total carbon nanotube length, for carbon nanotube lengths ranging between about 1 μm to about 500 μm. At very short carbon nanotube lengths (e.g., about 1 μm to about 4 μm), the tolerance can be plus or minus about 1 μm, that is, somewhat more than about 20% of the total carbon nanotube length.

As used herein, the term “uniform in density distribution” refers to a condition in which the carbon nanotube coverage density on a fiber material has a tolerance of plus or minus about 10% coverage over the fiber material surface area that is covered by carbon nanotubes.

The hydrophobicity and large effective surface area of carbon nanotubes makes these materials suitable for water filtration applications and other extractive processes, such as, for example, removal of hydrophobic materials (e.g., oils) from water or a like aqueous phase. Although carbon nanotubes have excellent sorption properties for hydrophobic materials, production costs have limited their implementation in this field and others. Another significant factor working against carbon nanotubes as a filtration medium is that no way has heretofore been found to take advantage of their sorption properties in a continuous manner. Specifically, once a quantity of carbon nanotubes has sorbed a quantity of hydrophobic material sufficient to reach its sorption capacity, it has heretofore been necessary for the spent carbon nanotubes to be replaced with fresh carbon nanotubes in order for the filtration process to continue.

The filtration systems and methods described herein overcome these inherent problems with carbon nanotubes as filtration media by providing continuous or near-continuous removal of hydrophobic materials using carbon nanotube-infused fiber materials of spoolable lengths. Carbon nanotube-infused fiber materials of spoolable lengths can be produced relatively cheaply, where the fiber material serves as a robust substrate for growing carbon nanotubes thereon. Even more importantly, the fiber material allows the carbon nanotubes to be readily manipulated in the present filtration systems and methods. Specifically, hydrophobic materials sorbed onto the carbon nanotube-infused fiber materials can be easily removed and the carbon nanotube-infused fiber materials reused thereafter for additional hydrophobic material removal processes.

In addition, the infused carbon nanotubes on a carbon nanotube-infused fiber material provide a large surface area for sorbing hydrophobic compounds from a liquid medium. Further, by transporting the carbon nanotube-infused fiber material through the liquid medium, the effective surface area for sorption can be further multiplied by the spoolable length of the carbon nanotube-infused fiber material.

In some embodiments, filtration systems described herein include a moving filtration medium containing a plurality of fibers of spoolable length, where the fibers are a carbon nanotube-infused fiber material.

In some embodiments, the filtration systems described herein include a plurality of rollers over which the moving filtration medium is transported. The plurality of rollers can guide the moving filtration medium through the filtration systems, as well as providing tensioning therein. In addition, the plurality of rollers can be used to position the moving filtration medium in a liquid medium being treated by the filtration systems. In some embodiments, the filtration systems include at least one dip roller and at least one alignment roller. As described herein, contact with the liquid medium being treated takes place at the at least one dip roller. In some embodiments, the depth positioning of the at least one dip roller can be variable. In such embodiments, the contact time of the moving filtration medium with the liquid medium can be varied by adjusting the depth positioning of the at least one dip roller.

In various embodiments, the filtration systems described herein include physical and/or chemical means for removing hydrophobic materials sorbed to the moving filtration medium. Physical means for removing sorbed hydrophobic materials include, for example, any device or process that is capable of evaporating, subliming, pressing or squeezing the sorbed hydrophobic materials from the moving filtration medium. Chemical means for removing the sorbed hydrophobic materials include, for example, solvent extraction baths and treatment solutions that chemically react with the sorbed hydrophobic materials to transform them into a more easily removable form. In general, chemical treatment solutions are selected such that they are non-reactive with the carbon nanotubes and/or the fiber material to which they are infused. In some embodiments, the filtration systems include at least one press roller through which the moving filtration medium is transported. In some embodiments, the filtration systems include at least one chemical extraction bath through which the moving filtration medium is transported. In some embodiments, the filtration systems include at least one press roller and at least one chemical extraction bath through which the moving filtration medium is transported.

In various embodiments, the filtration systems can further include at least one collection device that is operable for sequestering any liquids removed from the moving filtration medium at the at least one press roller. Liquids sequestered by the at least one collection device can include, for example, hydrophobic materials removed from the liquid medium, residual liquid medium remaining sorbed to the moving filtration medium, and/or residual solvents or reagents remaining sorbed to the moving filtration medium from chemical extraction baths. Illustrative collection devices can include, for example, catch pans, storage tanks, separation vessels and the like.

In some embodiments, the filtration systems further include a reel-to-reel processing system containing a first reel and a second reel. In general, the first reel is a payout reel and the second reel is a takeup reel such that the moving filtration medium is transported from the first reel to the second reel. Depending on the size of the first reel and the second reel and the chosen continuous length of the carbon nanotube-infused fiber material, the present filtration systems can be operated in a near-continuous manner for treating a liquid medium to remove hydrophobic materials therein. As one of ordinary skill in the art will recognize, when greater spoolable lengths of the carbon nanotube-infused fiber material are utilized, the present filtration systems can be operated for longer periods of time before interruption takes place to replace the moving filtration medium. In replacing the moving filtration medium, the payout reel and the takeup reel can simply be reversed so as to recycle the moving filtration medium, or the moving filtration medium can be replaced with a fresh portion of carbon nanotube-infused fiber material to continue the filtration process. If the moving filtration medium is not immediately reintroduced to the filtration system, the filtration medium on the takeup reel can be stored for later use, further treated to remove additional hydrophobic materials therefrom, or discarded. Although one of the many benefits of the present disclosure is the ability to reuse the moving filtration medium, the moving filtration medium can be discarded, inter alia, if the sorption properties have dropped below desired levels or if the fiber material is damaged or in danger of breaking.

In some embodiments, the moving filtration medium is in the form of a continuous loop structure that is continuously transported over a plurality of rollers. The rollers are used to continuously circulate the moving filtration medium through the present filtration systems. Several advantages are realized in embodiments containing the filtration medium in the form of a continuous loop. First, a continuous loop moving filtration medium allows the filtration systems to be operated in a fully continuous manner, with operational shutdowns for only routine maintenance envisioned. Second, a continuous loop moving filtration medium allows much shorter spoolable lengths of carbon nanotube-infused fiber materials to be employed, thereby reducing carbon nanotube production costs and allowing space savings to be realized in the filtration systems.

In some embodiments, filtration systems described herein include a reel-to-reel processing system containing a first reel and a second reel, a moving filtration medium connected to the reel-to-reel processing system, at least one alignment roller and at least one dip roller against which the moving filtration medium is tensioned, and at least one press roller through which the moving filtration medium is transported. The moving filtration medium contains a plurality of fibers of continuous length, where the fibers are a carbon nanotube-infused fiber material.

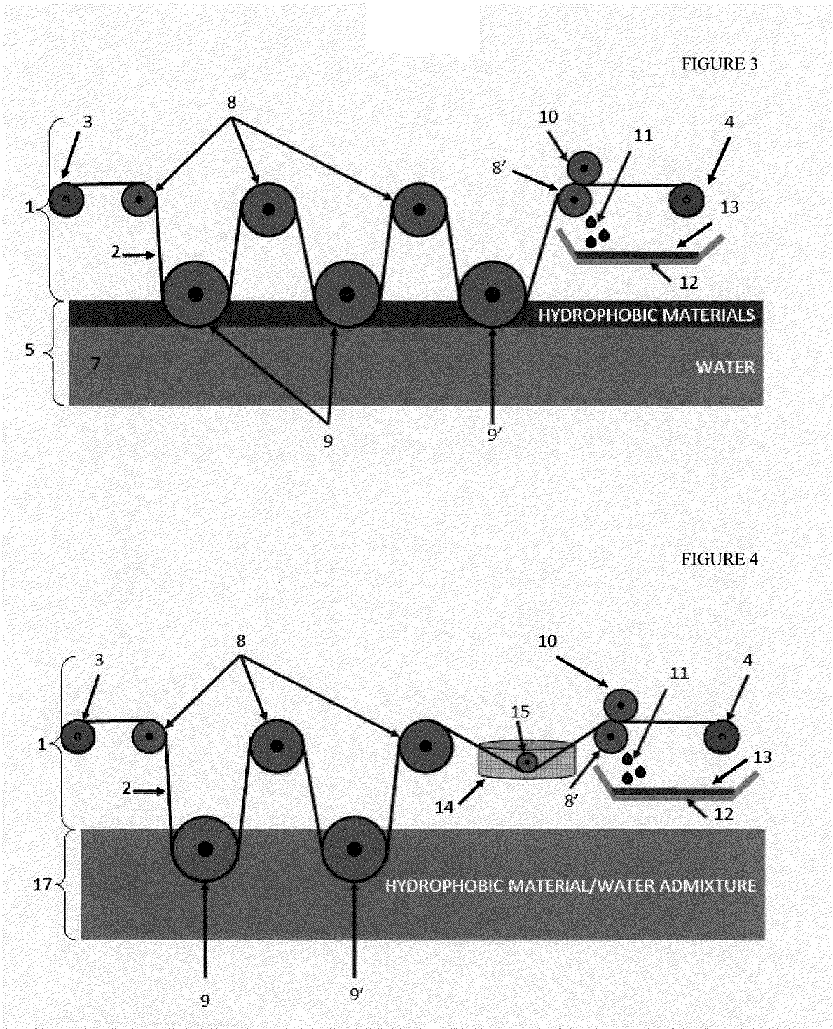

FIG. 3 shows a schematic of an illustrative embodiment of a filtration system containing a reel-to-reel processing system for a carbon nanotube-infused fiber material moving filtration medium. Filtration system 1 contains a spoolable length of carbon nanotube-infused fiber material 2 connected between payout reel 3 and takeup reel 4. Carbon nanotube-infused fiber material 2 contacts bilayer liquid medium 5, containing a hydrophobic material upper layer 6 and an aqueous lower layer 7, while being transported though alignment rollers 8 and 8′ and dip rollers 9 and 9′. In particular, carbon nanotube-infused fiber material 2 contacts hydrophobic material upper layer 6 while being tensioned against dip rollers 9 and 9′.

Although FIG. 3 has shown a filtration system 1 having four alignment rollers 8 and 8′ and three dip rollers 9 and 9′, any number of alignment rollers and dip rollers can be used in the constructing the present filtration systems. Depending on the size of filtration system 1 and the desired contact time of carbon nanotube-infused fiber material 2 with bilayer liquid medium 5, the number of dip rollers can be adjusted to vary the contact time and/or to provide a desired degree of tensioning, as will be recognized by one of ordinary skill in the art. Further, one of ordinary skill in the art will recognize that the contact time of carbon nanotube-infused fiber material 2 with bilayer liquid medium 5 can also be adjusted by varying the depth to which dip rollers 9 and 9′ contact bilayer liquid medium 5. For example, a bilayer liquid medium 5 having more concentrated hydrophobic materials therein will require shorter contact times to achieve adequate sorption of the hydrophobic materials onto carbon nanotube-infused fiber material 2. However, for a bilayer liquid medium 5 containing fairly dilute concentrations of the hydrophobic materials, longer contact times can be more preferable. As noted above, contact times can be varied by, for example, adjusting the linespeed at which carbon nanotube-infused fiber material 2 is transported through filtration system 1 and/or by adjusting the number and positioning of alignment rollers 8 and dip rollers 9 and 9′. In some embodiments, the depth positioning of dip rollers 9 and 9′ of filtration system 1 can be automatically or manually adjusted to accommodate a desired contact time with bilayer liquid medium 5.

FIG. 4 shows a schematic of an alternative illustrative embodiment of a filtration system containing a reel-to-reel processing system for a carbon nanotube-infused fiber material moving filtration medium. As shown in FIG. 4, the number of alignment rollers 8 and 8′ and dip rollers 9 and 9′ have been decreased to provide a shorter contact time of carbon nanotube-infused fiber material 2 with admixed liquid medium 17. FIG. 4 also illustrates that the depth positioning of dip rollers 9 and 9′ can be adjusted to provide a longer contact time. In addition, FIG. 4 shows that filtration system 1 can be utilized to remove hydrophobic materials from admixed liquid medium 17 containing admixed hydrophobic materials, as opposed to bilayer liquid medium 5 illustrated in FIG. 3. Other new elements of filtration system 1 in FIG. 4 are discussed further hereinbelow.

Referring again to FIG. 3, carbon nanotube-infused fiber material 2 exits bilayer liquid medium 5 after passing under dip roller 9′. Carbon nanotube-infused fiber material 2 then contacts alignment roller 8′, where press roller 10 applies mechanical force to remove hydrophobic materials 11 from carbon nanotube-infused fiber material 2. The hydrophobic materials 11 so removed are sequestered in catch pan 12. Sequestered hydrophobic materials 13 in catch pan 12 can then be dealt with at a later time. Once hydrophobic materials 11 have been removed from carbon nanotube-infused fiber material 2, the carbon nanotube-infused fiber material 2 is wound upon takeup reel 4. As described in more detail hereinabove, carbon nanotube-infused fiber material 2 on takeup reel 4 can then be recycled for another filtration pass, discarded or subjected to further cleaning prior to use in another filtration pass.

Referring now to FIG. 4, it can be seen that alternative embodiments of filtration system 1 can have a chemical extraction bath 14 to assist in removal of hydrophobic materials from carbon nanotube-infused fiber material 2. Chemical extraction bath 14 contains dip roller 15 to assist in positioning of carbon nanotube-infused fiber material 2 therein. Although FIG. 4 shows only one dip roller 15 in chemical extraction bath 14, there can be more than one dip roller therein. Further, there can be additional alignment rollers (not shown) associated with dip roller 15. In addition, although FIG. 4 shows only one chemical extraction bath 14, multiple chemical extraction baths can be utilized in other embodiments. Positioning of chemical extraction bath 14 can be before of after press roller 10. Upon exiting chemical extraction bath 14, carbon nanotube-infused fiber material 2 contacts alignment roller 8′, with separation of hydrophobic materials completed as described above for FIG. 3.

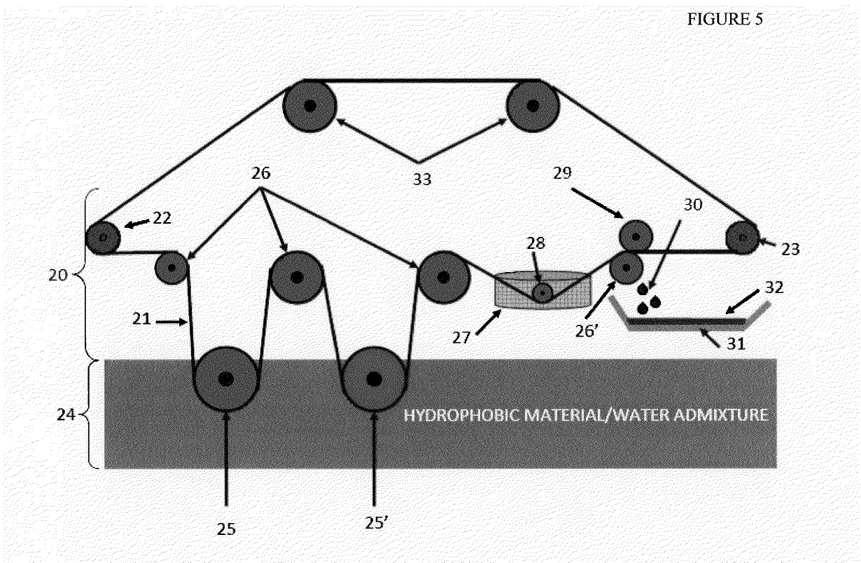

As also noted above, the present filtration systems can be modified to operate in a continuous manner. FIG. 5 shows a schematic of an illustrative filtration system containing a continuous loop of a carbon nanotube-infused fiber material moving filtration medium. Continuous filtration system 20 contains a continuous loop of carbon nanotube-infused fiber material 21 tensioned over rollers 22, 23 and 33. The continuous loop of carbon nanotube-infused fiber material 21 contacts admixed liquid medium 24 containing an admixture of a hydrophobic material and water. As in the previously described embodiments of a reel-to-reel filtration system, admixed liquid medium 24 can also be a bilayer liquid medium containing a hydrophobic material and an aqueous layer. Dip rollers 25 and 25′ and alignment rollers 26 guide the continuous loop of carbon nanotube-infused fiber material 21 through admixed liquid medium 24. As in the previously described embodiments of a reel-to-reel filtration system, the positioning and number of dip rollers 25 can be adjusted to change the contact time of carbon nanotube-infused fiber material 21 with admixed liquid medium 24.

As in the embodiment of a reel-to-reel filtration system shown in FIG. 4, continuous filtration system 20 shown in FIG. 5 also contains chemical extraction bath 27 for removing hydrophobic materials from carbon nanotube-infused fiber material 21. Chemical extraction bath 27 can contain any number of dip rollers 28 therein, optionally in combination with alignment rollers (not shown). Further, any number of chemical extraction baths 27 can be used in continuous filtration system 20. Optionally, chemical extraction bath 27 and alignment roller 28 can be omitted from continuous filtration system 20.

Upon exiting chemical extraction bath 27, the continuous loop of carbon nanotube-infused fiber material 21 contacts alignment roller 26′, where press roller 29 applies mechanical force to remove hydrophobic materials 30 from carbon nanotube-infused fiber material 21. The removed hydrophobic materials 30 are sequestered in catch pan 31. Sequestered hydrophobic materials 32 in catch pan 31 can then be dealt with at a later time. After removal of hydrophobic materials 30, the continuous loop of carbon nanotube-infused fiber material 21 is cycled over rollers 23 and 33 and returned to roller 22 to begin the filtration process anew. Although continuous filtration system 20 has been illustrated with two rollers 33, any number of such rollers can be used to provide satisfactory cycling of the continuous loop of carbon nanotube-infused fiber material 21, and the matter of choosing the proper number of rollers 33 is a matter of engineering design.

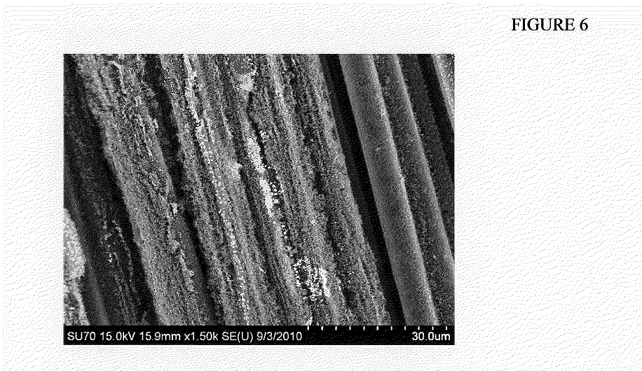

In general, the carbon nanotube-infused fiber material of the moving filtration medium can be in any of a variety of forms containing a plurality of fibers. In various embodiments, the plurality of fibers of continuous length can be in a form such as, for example, yarns, fiber tows, tapes, braids, woven fabrics, non-woven fabrics, fiber plies and fiber mats. In various embodiments, the carbon nanotube-infused fiber material includes a fiber material that has carbon nanotubes infused thereto. In any of the various embodiments described herein, the fiber material infused with carbon nanotubes can include, for example, glass fibers, carbon fibers, metal fibers, ceramic fibers, and organic fibers (e.g., aramid fibers). In some embodiments, the fiber material infused with carbon nanotubes can include, for example, glass fibers, carbon fibers, metal fibers, ceramic fibers, organic fibers, silicon carbide (SiC) fibers, boron carbide (B₄C) fibers, silicon nitride (Si₃N₄) fibers, aluminum oxide (Al₂O₃) fibers and various combinations thereof. Further, the various fiber material forms mentioned above can contain any mixture of these or other fiber types. FIG. 6 shows an illustrative SEM image of a fabric weave of carbon nanotube-infused carbon fibers. In various embodiments, the individual filaments of the fiber material have a diameter ranging between about 1 μm and about 100 μm.

Fiber tows include loosely associated bundles of untwisted fibers. In general, the fiber diameter in a fiber tow is typically uniform. Fiber tows have varying weights described by their ‘tex’ range and a tex range (expressed as weight in grams per 1000 linear meters) that is usually between about 200 and 2,000. In addition, fiber tows are frequently characterized by the number of thousands of fibers in the fiber tow, such as, for example, a 12K tow, a 24K tow, a 48K tow, and the like.

Fiber tows can be twisted together to give yarns in some embodiments. Yarns include closely associated bundles of twisted fibers. As in the parent fiber tows, each fiber diameter in a yarn is relatively uniform. Yarns also have varying weights described by their tex value. For yarns, a typical tex range is usually between about 200 and about 2,000.

Fiber braids are rope-like structures of densely packed fibers. Such rope-like structures can be assembled from yarns or fiber tows, for example. Braided structures can include a hollow portion. Alternately, a braided structure can be assembled about another core material.

Tapes are fiber materials that can be assembled as weaves or as non-woven flattened fiber tows, for example. Tapes can vary in width and are generally two-sided structures similar to a ribbon. In the various embodiments described herein, carbon nanotubes can be infused to the fiber material of a tape on one or both sides of a tape. In addition, carbon nanotubes of different types, diameters or lengths can be grown on each side of a tape.

Fiber materials can also be organized into fabric or sheet-like structures. These include, for example, woven fabrics, non-woven fiber mats and fiber plies, in addition to the tapes described above. Such higher ordered structures can be assembled from parent fiber tows, yarns, filaments or the like, with the carbon nanotubes already infused thereon. Alternately, such higher ordered structures can also serve as a substrate for continuous infusion of carbon nanotubes thereon.

As described in co-pending applications, a fiber material is modified to provide a layer (typically no more than a monolayer) of catalytic nanoparticles on the fiber material for the purpose of growing carbon nanotubes thereon. In various embodiments, the catalytic nanoparticles used for mediating carbon nanotube growth are transition metals and various salts thereof.

In some embodiments, the fiber materials further include a barrier coating. Illustrative barrier coatings can include, for example, alkoxysilanes, methylsiloxanes, alumoxanes, alumina nanoparticles, spin on glass and glass nanoparticles. For example, in an embodiment the barrier coating is Accuglass T-11 Spin-On Glass (Honeywell International Inc., Morristown, N.J.). In some embodiments, the catalytic nanoparticles for carbon nanotube synthesis can be combined with the uncured barrier coating material and then applied to the fiber material together. In other embodiments, the barrier coating material can be added to the fiber material prior to deposition of the catalytic nanoparticles. In general, the barrier coating is sufficiently thin to allow exposure of the catalytic nanoparticles to a carbon feedstock gas for carbon nanotube growth. In some embodiments, the thickness of the barrier coating is less than or about equal to the effective diameter of the catalytic nanoparticles. In some embodiments, the thickness of the barrier coating is in a range between about 10 nm to about 100 nm. In other embodiments, the thickness of the barrier coating is in a range between about 10 nm to about 50 nm, including 40 nm. In some embodiments, the thickness of the barrier coating is less than about 10 nm, including about 1 nm, about 2 nm, about 3 nm, about 4 nm, about 5 nm, about 6 nm, about 7 nm, about 8 nm, about 9 nm, and about 10 nm, including all values and subranges therebetween.

Without being bound by theory, the barrier coating can serve as an intermediate layer between the fiber material and the carbon nanotubes and mechanically infuses the carbon nanotubes to the fiber material. Such mechanical infusion provides a robust system in which the fiber material serves as a platform for organizing the carbon nanotubes, while allowing the beneficial properties of the carbon nanotubes to be conveyed to the fiber material. Moreover, benefits of including a barrier coating include protection of the fiber material from chemical damage due to moisture exposure and/or thermal damage at the elevated temperatures used to promote carbon nanotube growth. In some embodiments, the barrier coating is removed after carbon nanotube infusion. However, in other embodiments, the barrier coating can be left intact. In some embodiments of the present filtration systems, the barrier coating can be removed during the process of removing hydrophobic materials from a liquid medium.

After deposition of the catalytic nanoparticles, a chemical vapor deposition (CVD)-based process is used in some embodiments to continuously grow carbon nanotubes on the fiber material. The resultant carbon nanotube-infused fiber material is itself a composite architecture. More generally, the carbon nanotubes can be infused to the fiber material using any technique known to those of ordinary skill in the art. Illustrative techniques for carbon nanotube synthesis include, for example, micro-cavity, thermal or plasma-enhanced CVD techniques, laser ablation, arc discharge, flame synthesis and high pressure carbon monoxide (HiPCO) synthesis. In some embodiments, the CVD-based growth can be plasma-enhanced by providing an electric field during the growth process such that the carbon nanotubes follow the direction of the electric field.

In some embodiments, the carbon nanotubes infused to the fiber material are substantially perpendicular to the longitudinal axis of the fiber material. Stated another way, the carbon nanotubes infused to the fiber material are circumferentially perpendicular to the fiber surface. This orientation of the carbon nanotubes provides a high carbon nanotube surface area per unit weight of fiber material. However, in alternative embodiments, the carbon nanotubes infused to the fiber material can be substantially parallel to the longitudinal axis of the fiber material.

In some embodiments, the carbon nanotubes infused to the fiber material are unbundled, thereby facilitating strong bonding between the fiber material and the carbon nanotubes. Unbundled carbon nanotubes also allow a maximized carbon nanotube surface area exposure to be realized. However, in other embodiments, the carbon nanotubes infused to the fiber material can be made in the form of a highly uniform, entangled carbon nanotube mat by reducing the growth density during carbon nanotube synthesis. In such embodiments, the carbon nanotubes do not grow dense enough to align the carbon nanotubes substantially perpendicular to the longitudinal axis of the fiber material.

The average length of the carbon nanotubes infused to the fiber material can be influenced, for example, by the exposure time to carbon nanotube growth conditions, the growth temperature, and flow rates and pressures of carbon-containing feedstock gas (e.g., acetylene, ethylene and/or ethanol) and carrier gases (e.g., helium, argon, and/or nitrogen) used during carbon nanotube synthesis. Exposure time can be modulated, for example, by adjusting the linespeed at which the fiber material is transported through the reactor used for infusing carbon nanotubes to the fiber material. In general, during a carbon nanotube synthesis, the carbon-containing feedstock gas is provided in a range of about 0.1% to about 15% of the total reaction volume.

In various embodiments, the carbon nanotubes infused to the fiber material are generally uniform in length. In some embodiments, an average length of the infused carbon nanotubes is between about 1 μm and about 500 μm, including about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, about 500 μm, and all values and subranges therebetween. In some embodiments, an average length of the infused carbon nanotubes is less than about 1 μm, including about 0.5 μm, for example, and all values and subranges therebetween. In some embodiments, an average length of the infused carbon nanotubes is between about 1 μm and about 10 μm, including, for example, about 1 μm, about 2 μm, about 3 μm, about 4 μm, about 5 μm, about 6 μm, about 7 μm, about 8 μm, about 9 μm, about 10 μm, and all values and subranges therebetween. In some embodiments, an average length of the infused carbon nanotubes ranges between about 25 μm and about 500 μm, or between about 50 μm and about 500 μm, or between about 100 μm and about 500 μm. In still other embodiments, an average length of the infused carbon nanotubes is greater than about 500 μm, including, for example, about 510 μm, about 520 μm, about 550 μm, about 600 μm, about 700 μm, and all values and subranges therebetween.

Typically, a carbon nanotube's diameter is approximately that of the catalytic nanoparticle that catalyzes its formation. Therefore, the carbon nanotube's properties can be additionally controlled by, for example, adjusting the size of the catalytic nanoparticles used to synthesize the carbon nanotubes. By way of non-limiting example, catalytic nanoparticles having a diameter of about 1 nm can be used to infuse a fiber material with single-wall carbon nanotubes. Larger catalytic nanoparticles can be used to prepare predominantly multi-wall carbon nanotubes, which have larger diameters because of their multiple nanotube layers, or mixtures of single-wall and multi-wall carbon nanotubes. In some embodiments of the present disclosure, the carbon nanotubes infused to the fiber material can be single-wall carbon nanotubes. In other embodiments, however, the carbon nanotubes infused to the fiber material can be double- or multi-wall carbon nanotubes or mixtures of single-wall carbon nanotubes and double- or multi-wall carbon nanotubes.

In some embodiments, the carbon nanotubes infused to the fiber material are generally uniform in density distribution, referring to the uniformity of the carbon nanotube density on the fiber material. As defined above, the tolerance for a uniform density distribution is plus or minus about 10% over the fiber material surface area that is infused with carbon nanotubes. By way of non-limiting example, this tolerance is equivalent to about ±1500 carbon nanotubes/μm² for a carbon nanotube having a diameter of 8 nm and 5 walls. Such a figure assumes that the space inside the carbon nanotube is fillable. In some embodiments, the maximum carbon nanotube density, expressed as a percent coverage of the fiber material (i.e., the percentage of the fiber material surface area that is covered with carbon nanotubes) can be as high as about 55%, again assuming a carbon nanotube having an 8 nm diameter, 5 walls and fillable space within. 55% surface area coverage is equivalent to about 15,000 carbon nanotubes/μm² for a carbon nanotube having the referenced dimensions. In some embodiments, the density of coverage is up to about 15,000 carbon nanotubes/μm². One of ordinary skill in the art will recognize that a wide range of carbon nanotube densities can be attained by varying the disposition of the catalytic nanoparticles on the surface of the fiber material, the exposure time to carbon nanotube growth conditions, and the actual growth conditions themselves used to infuse the carbon nanotubes to the fiber material.

In some embodiments, a weight percentage of the carbon nanotubes of the fiber material is determined by an average length of the carbon nanotubes. In some or other embodiments, a weight percentage of the carbon nanotubes of the fiber material is further determined by a density of coverage of carbon nanotubes infused to the fiber material. In some embodiments, the fiber material contains up to about 40% carbon nanotubes by weight. In some embodiments, the fiber material contains between about 0.5% and about 40% carbon nanotubes by weight. In other embodiments, the fiber material contains up to about 30% carbon nanotubes by weight. According to the present embodiments, higher carbon nanotube coverage densities on the fiber material give better filtration, since they have a greater carbon nanotube surface area for sorbing hydrophobic materials thereto.

In some embodiments, the infusion of carbon nanotubes to the fiber material can serve further purposes including, for example, as a sizing agent to protect the fiber material from moisture, oxidation, abrasion and/or compression. Such a carbon nanotube-based sizing agent can be applied to a fiber material in lieu of or in addition to conventional sizing agents. Conventional sizing agents vary widely in type and function and include, for example, surfactants, anti-static agents, lubricants, siloxanes, alkoxysilanes, aminosilanes, silanes, silanols, polyvinyl alcohol, starch, and mixtures thereof.

In some embodiments, a conventional sizing agent can be removed from the fiber material prior to infusion with the carbon nanotubes. Optionally, the conventional sizing agent can be replaced with another conventional sizing agent. In some embodiments, a conventional sizing agent can be removed from the carbon nanotube-infused fiber material during the process of removing a hydrophobic material from a liquid medium. In instances where the conventional sizing agent is removable during the process of removing a hydrophobic material from a liquid medium, if it is desired to maintain a conventional sizing agent in the carbon nanotube-infused fiber material, the original conventional sizing agent can be replaced with another conventional sizing agent that is more compatible with the liquid medium and/or chemical extraction baths used in the removal process.

In other various embodiments, methods utilizing moving carbon nanotube-infused fiber material filtration media are described herein. In some embodiments, the methods can be used to remove a hydrophobic material from a liquid medium. In some or other embodiments, the methods can be modified to isolate and purify a desired trace hydrophobic material from a liquid medium.

In some embodiments, methods described herein include providing a moving filtration medium containing a plurality of fibers of spoolable length, where the fibers are a carbon nanotube-infused fiber material; transporting the moving filtration medium through a liquid medium containing a hydrophobic material; sorbing at least a portion of the hydrophobic material from the liquid medium onto the moving filtration medium; and transporting the moving filtration medium through at least one press roller after sorbing the hydrophobic material. In some embodiments, the present methods further include sequestering any hydrophobic material removed at the at least one press roller in a collection device, such as those described hereinabove.

In some embodiments, the process of transporting the moving filtration medium through a liquid medium involves passing the moving filtration medium over at least one alignment roller and at least one dip roller. In some embodiments, the moving filtration medium is transported in a reel-to-reel processing system between a first reel and a second reel. In other embodiments, the moving filtration medium can be a closed loop structure that is continuously transported over a plurality of rollers.

In some embodiments, the present methods can further include transporting the moving filtration medium through at least one chemical extraction bath after sorbing the hydrophobic material. Additional details concerning chemical extraction baths are set forth hereinabove.

In some embodiments of the present methods, the plurality of fibers can be in a form such as, for example, yarns, fiber tows, tapes, braids, woven fabrics, non-woven fabrics, fiber plies and fiber mats.

In general, any liquid medium that contains a hydrophobic material can be treated according to the present methods. In some embodiments, the liquid medium is a bilayer having an upper layer containing the hydrophobic material and a lower aqueous layer. In alternative embodiments, the hydrophobic material can form the lower layer if its density is sufficiently high. In some embodiments, the bilayer is an oil-water bilayer. In other embodiments, the liquid medium can be an aqueous phase containing an admixed hydrophobic material. In some embodiments, the admixed hydrophobic material is oil. Thus, in some embodiments of the present methods, the liquid medium can be an oil-water bilayer, while in other embodiments, the liquid medium can be oil admixed with water or a like aqueous phase.

In some embodiments, the liquid medium can be a water source containing trace organic pollutants (e.g., pesticides, industrial chemicals, and solvent residues). In various embodiments, the water source can be natural or manmade. For example, in some embodiments, the present treatment methods can be used to treat a stream, pond or like water source that is in need of removal of trace organic pollutants. In other embodiments, the present methods can be used to treat a groundwater source containing trace organic pollutants. In still other embodiments, the present methods can be used to treat an industrial runoff stream or detention pond that is in need of removal of organic pollutants.

In some embodiments, the present methods can be used to isolate a hydrophobic material from a liquid medium that is otherwise relatively inaccessible. For example, in some embodiments, the liquid medium can be oil in a subterranean formation, optionally containing water and/or particulate matter (e.g., sand and silts). In such embodiments, the present methods can be used to remove the oil from the subterranean formation while leaving behind other formation components, particularly water.

In some embodiments, the present methods can be modified to isolate and purify a desired hydrophobic material from a liquid medium. For example, a low-yielding organic compound can be isolated from an aqueous phase by employing the present methods. In some embodiments, the liquid medium can be a fermentation broth, where the hydrophobic material being isolated and purified is a fermentation product.

In some embodiments, methods described herein include providing a moving filtration medium containing a plurality of fibers of spoolable length, where the fibers are a carbon nanotube-infused fiber material; transporting the moving filtration medium through a liquid medium containing a trace hydrophobic compound; sorbing at least a portion of the trace hydrophobic compound from the liquid medium onto the moving filtration medium; and isolating the trace hydrophobic compound from the moving filtration medium.

In some embodiments, methods described herein include providing a moving filtration medium containing a plurality of fibers of spoolable length that is connected to a reel-to-reel processing system containing a first reel and a second reel, where the fibers are a carbon nanotube-infused fiber material; transporting the moving filtration medium through a liquid medium containing a hydrophobic material; sorbing at least a portion of the hydrophobic material from the liquid medium onto the moving filtration medium; transporting the moving filtration medium through at least one press roller after sorbing the hydrophobic material; and sequestering any hydrophobic material removed at the at least one press roller in a collection device.

Embodiments disclosed herein utilize carbon nanotube-infused fibers that can be readily prepared by methods described in U.S. patent application Ser. Nos. 12/611,073, 12/611,101, 12/611,103, and 12/938,328, each of which is incorporated by reference herein in its entirety. A brief description of the processes described therein follows.

To infuse carbon nanotubes to a fiber material, the carbon nanotubes are synthesized directly on the fiber material. In some embodiments, this is accomplished by first disposing a carbon nanotube-forming catalyst (e.g., catalytic nanoparticles) on the fiber material. A number of preparatory processes can be performed prior to this catalyst deposition.

In some embodiments, the fiber material can be optionally treated with a plasma to prepare the fiber surface to accept the catalyst. For example, a plasma treated glass fiber material can provide a roughened glass fiber surface in which the carbon nanotube-forming catalyst can be deposited. In some embodiments, the plasma also serves to “clean” the fiber surface. The plasma process for “roughing” the fiber surface thus facilitates catalyst deposition. The roughness is typically on the scale of nanometers. In the plasma treatment process, craters or depressions are formed that are nanometers deep and nanometers in diameter. Such surface modification can be achieved using a plasma of any one or more of a variety of different gases, including, without limitation, argon, helium, oxygen, ammonia, nitrogen and hydrogen.

In some embodiments, where a fiber material being employed has a sizing material associated with it, such sizing can be optionally removed prior to catalyst deposition. Optionally, the sizing material can be removed after catalyst deposition. In some embodiments, sizing material removal can be accomplished during carbon nanotube synthesis or just prior to carbon nanotube synthesis in a pre-heat step. In other embodiments, some sizing materials can remain throughout the entire carbon nanotube synthesis process.

Yet another optional step prior to or concomitant with the deposition of the carbon nanotube-forming catalyst is the application of a barrier coating onto the fiber material. Barrier coatings are materials designed to protect the integrity of sensitive fiber materials, such as carbon fibers, organic fibers, glass fibers, metal fibers, and the like. Such a barrier coating can include, for example, an alkoxysilane, an alumoxane, alumina nanoparticles, spin on glass and glass nanoparticles. The carbon nanotube-forming catalyst can be added to the uncured barrier coating material and then applied to the fiber material together, in one embodiment. In other embodiments the barrier coating material can be added to the fiber material prior to deposition of the carbon nanotube-forming catalyst. In such embodiments, the barrier coating can be partially cured prior to catalyst deposition. The barrier coating material can be of a sufficiently thin thickness to allow exposure of the carbon nanotube-forming catalyst to the carbon feedstock gas for subsequent CVD or like carbon nanotube growth process. In some embodiments, the barrier coating thickness is less than or about equal to the effective diameter of the carbon nanotube-forming catalyst. Once the carbon nanotube-forming catalyst and the barrier coating are in place, the barrier coating can be fully cured. In some embodiments, the thickness of the barrier coating can be greater than the effective diameter of the carbon nanotube-forming catalyst so long as it still permits access of carbon feedstock gases to the sites of the catalyst. Such barrier coatings can be sufficiently porous to allow access of carbon feedstock gases to the carbon nanotube-forming catalyst.

Without being bound by theory, the barrier coating can serve as an intermediate layer between the fiber material and the carbon nanotubes and can also assist in mechanically infusing the carbon nanotubes to the fiber material. Such mechanical infusion via a barrier coating provides a robust system for carbon nanotube growth in which the fiber material serves as a platform for organizing the carbon nanotubes, while still allowing the beneficial carbon nanotube properties to be conveyed to the fiber material. The benefits of mechanical infusion with a barrier coating are similar to the indirect type infusion described hereinabove. Moreover, the benefits of including a barrier coating include, for example, the immediate protection it provides the fiber material from chemical damage due to moisture exposure and/or any thermal damage at the elevated temperatures used to promote carbon nanotube growth.

As described further below, the carbon nanotube-forming catalyst can be prepared as a liquid solution that contains the carbon nanotube-forming catalyst as transition metal catalytic nanoparticles. The diameters of the synthesized carbon nanotubes are related to the size of the transition metal catalytic nanoparticles as described above.

Carbon nanotube synthesis can be based on a chemical vapor deposition (CVD) process or related carbon nanotube growth process which occurs at elevated temperatures. The specific temperature is a function of catalyst choice, but can typically be in a range of about 500° C. to about 1000° C. Accordingly, carbon nanotube synthesis involves heating the fiber material to a temperature in the aforementioned range to support carbon nanotube growth.

In some embodiments, CVD-promoted carbon nanotube growth on the catalyst-laden fiber material is performed. The CVD process can be promoted by, for example, a carbon-containing feedstock gas such as acetylene, ethylene, and/or ethanol. The carbon nanotube growth processes generally use an inert gas (e.g., nitrogen, argon, and/or helium) as a primary carrier gas. The carbon-containing feedstock gas is typically provided in a range from between about 0.1% to about 15% of the total mixture. A substantially inert environment for CVD growth can be prepared by removal of moisture and oxygen from the growth chamber.

In the carbon nanotube growth process, carbon nanotubes grow at the sites of transition metal catalytic nanoparticles that are operable for carbon nanotube growth. The presence of a strong plasma-creating electric field can be optionally employed to affect carbon nanotube growth. That is, the growth tends to follow the direction of the electric field. By properly adjusting the geometry of the plasma spray and electric field, vertically aligned carbon nanotubes (i.e., perpendicular to the longitudinal axis of the fiber material) can be synthesized. Under certain conditions, even in the absence of a plasma, closely-spaced carbon nanotubes can maintain a substantially vertical growth direction resulting in a dense array of carbon nanotubes resembling a carpet or forest.

The operation of disposing catalytic nanoparticles on the fiber material can be accomplished by a number of techniques including, for example, spraying or dip coating a solution of catalytic nanoparticles or by gas phase deposition, which can occur by a plasma process, for example. Thus, in some embodiments, after forming a catalyst solution in a solvent, the catalyst can be applied by spraying or dip coating the fiber material with the solution, or combinations of spraying and dip coating. Either technique, used alone or in combination, can be employed once, twice, thrice, four times, up to any number of times to provide a fiber material that is sufficiently uniformly coated with catalytic nanoparticles that are operable for formation of carbon nanotubes. When dip coating is employed, for example, a fiber material can be placed in a first dip bath for a first residence time in the first dip bath. When employing a second dip bath, the fiber material can be placed in the second dip bath for a second residence time. For example, fiber materials can be subjected to a solution of carbon nanotube-forming catalyst for between about 3 seconds to about 90 seconds depending on the dip configuration and linespeed. Employing spraying or dip coating processes, a fiber material with a catalyst surface density of less than about 5% surface coverage to as high as about 80% surface coverage can be obtained. At higher surface densities (e.g., about 80%), the carbon nanotube-forming catalyst nanoparticles are nearly a monolayer. In some embodiments, the process of coating the carbon nanotube-forming catalyst on the fiber material produces no more than a monolayer. For example, carbon nanotube growth on a stack of carbon nanotube-forming catalyst can erode the degree of infusion of the carbon nanotubes to the fiber material. In other embodiments, transition metal catalytic nanoparticles can be deposited on the fiber material using evaporation techniques, electrolytic deposition techniques, and other processes known to those of ordinary skill in the art, such as addition of the transition metal catalyst to a plasma feedstock gas as a metal organic, metal salt or other composition promoting gas phase transport.

Because processes to manufacture carbon nanotube-infused fibers are designed to be continuous, a spoolable fiber material can be dip-coated in a series of baths where dip coating baths are spatially separated. In a continuous process in which nascent fibers are being generated de novo, such as newly formed glass fibers from a furnace, dip bath or spraying of a carbon nanotube-forming catalyst can be the first step after sufficiently cooling the newly formed fiber material. In some embodiments, cooling of newly formed glass fibers can be accomplished with a cooling jet of water which has the carbon nanotube-forming catalyst particles dispersed therein.

In some embodiments, application of a carbon nanotube-forming catalyst can be performed in lieu of application of a sizing when generating a fiber and infusing it with carbon nanotubes in a continuous process. In other embodiments, the carbon nanotube-forming catalyst can be applied to newly formed fiber materials in the presence of other sizing agents. Such simultaneous application of a carbon nanotube-forming catalyst and other sizing agents can provide the carbon nanotube-forming catalyst in surface contact with the fiber material to ensure carbon nanotube infusion. In yet further embodiments, the carbon nanotube-forming catalyst can be applied to nascent fibers by spray or dip coating while the fiber material is in a sufficiently softened state, for example, near or below the annealing temperature, such that the carbon nanotube-forming catalyst is slightly embedded in the surface of the fiber material. When depositing the carbon nanotube-forming catalyst on hot glass fiber materials, for example, care should be given to not exceed the melting point of the carbon nanotube-forming catalyst, thereby causing nanoparticle fusion and loss of control of the carbon nanotube characteristics (e.g., diameter) as a result.

The carbon nanotube-forming catalyst solution can be a transition metal nanoparticle solution of any d-block transition metal. In addition, the nanoparticles can include alloys and non-alloy mixtures of d-block metals in elemental form, in salt form, and mixtures thereof. Such salt forms include, without limitation, oxides, carbides, and nitrides, acetates, nitrates, and the like. Non-limiting illustrative transition metal nanoparticles include, for example, Ni, Fe, Co, Mo, Cu, Pt, Au, and Ag, salts thereof, and mixtures thereof. In some embodiments, such carbon nanotube-forming catalysts are disposed on the fiber material by applying or infusing a carbon nanotube-forming catalyst directly to the fiber material. Many nanoparticle transition metal catalysts are readily commercially available from a variety of suppliers, including, for example, Ferrotec Corporation (Bedford, N.H.).

Catalyst solutions used for applying the carbon nanotube-forming catalyst to the fiber material can be in any common solvent that allows the carbon nanotube-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the carbon nanotube-forming catalytic nanoparticles therein. Concentrations of carbon nanotube-forming catalyst in the catalyst solution can be in a range from about 1:1 to about 1:10,000 catalyst to solvent.

In some embodiments, after applying the carbon nanotube-forming catalyst to the fiber material, the fiber material can be optionally heated to a softening temperature. This step can aid in embedding the carbon nanotube-forming catalyst in the surface of the fiber material to encourage seeded growth and prevent tip growth where the catalyst floats at the tip of the leading edge a growing carbon nanotube. In some embodiments heating of the fiber material after disposing the carbon nanotube-forming catalyst on the fiber material can be at a temperature between about 500° C. and about 1000° C. Heating to such temperatures, which can also be used for carbon nanotube growth, can serve to remove any pre-existing sizing agents on the fiber material allowing deposition of the carbon nanotube-forming catalyst directly on the fiber material. In some embodiments, the carbon nanotube-forming catalyst can also be placed on the surface of a sizing coating prior to heating. The heating step can be used to remove sizing material while leaving the carbon nanotube-forming catalyst disposed on the surface of the fiber material. Heating at these temperatures can be performed prior to or substantially simultaneously with the introduction of a carbon-containing feedstock gas for carbon nanotube growth.

In some embodiments, the process of infusing carbon nanotubes to a fiber material includes removing sizing agents from the fiber material, applying a carbon nanotube-forming catalyst to the fiber material after sizing removal, heating the fiber material to at least about 500° C., and synthesizing carbon nanotubes on the fiber material. In some embodiments, operations of the carbon nanotube infusion process include removing sizing from a fiber material, applying a carbon nanotube-forming catalyst to the fiber material, heating the fiber material to a temperature operable for carbon nanotube synthesis and spraying a carbon plasma onto the catalyst-laden fiber material. Thus, where commercial fiber materials are employed, processes for constructing carbon nanotube-infused fibers can include a discrete step of removing sizing from the fiber material before disposing the catalytic nanoparticles on the fiber material. Some commercial sizing materials, if present, can prevent surface contact of the carbon nanotube-forming catalyst with the fiber material and inhibit carbon nanotube infusion to the fiber material. In some embodiments, where sizing removal is assured under carbon nanotube growth conditions, sizing removal can be performed after deposition of the carbon nanotube forming catalyst but just prior to or during providing a carbon-containing feedstock gas.

The step of synthesizing carbon nanotubes can include numerous techniques for forming carbon nanotubes, including, without limitation, micro-cavity, thermal or plasma-enhanced CVD techniques, laser ablation, arc discharge, flame synthesis, and high pressure carbon monoxide (HiPCO). During CVD, in particular, a sized fiber material with carbon nanotube-forming catalyst disposed thereon, can be used directly. In some embodiments, any conventional sizing agents can be removed during carbon nanotube synthesis. In some embodiments other sizing agents are not removed, but do not hinder carbon nanotube synthesis and infusion to the fiber material due to the diffusion of the carbon-containing feedstock gas through the sizing. In some embodiments, acetylene gas can be ionized to create a jet of cold carbon plasma for carbon nanotube synthesis. The plasma is directed toward the catalyst-laden fiber material. Thus, in some embodiments synthesizing carbon nanotubes on a fiber material includes (a) forming a carbon plasma; and (b) directing the carbon plasma onto the catalyst disposed on the fiber material. The diameters of the carbon nanotubes that are grown are dictated by the size of the carbon nanotube-forming catalyst. In some embodiments, a sized fiber material can be heated to between about 550° C. and about 800° C. to facilitate carbon nanotube growth. To initiate the growth of carbon nanotubes, two or more gases are bled into the reactor: an inert carrier gas (e.g., argon, helium, or nitrogen) and a carbon-containing feedstock gas (e.g., acetylene, ethylene, ethanol or methane). Carbon nanotubes grow at the sites of the carbon nanotube-forming catalyst.

In some embodiments, a CVD growth process can be plasma-enhanced. A plasma can be generated by providing an electric field during the growth process. Carbon nanotubes grown under these conditions can follow the direction of the electric field. Thus, by adjusting the geometry of the reactor, vertically aligned carbon nanotubes can be grown where the carbon nanotubes are substantially perpendicular to the longitudinal axis of the fiber material (i.e., radial growth). In some embodiments, a plasma is not required for radial growth to occur about the fiber material. For fiber materials that have distinct sides such as, for example, tapes, mats, fabrics, plies, and the like, the carbon nanotube-forming catalyst can be disposed on one or both sides of the fiber material. Correspondingly, under such conditions, carbon nanotubes can be grown on one or both sides of the fiber material as well.

As described above, the carbon nanotube synthesis is performed at a rate sufficient to provide a continuous process for infusing spoolable length fiber materials with carbon nanotubes. Numerous apparatus configurations facilitate such a continuous synthesis as exemplified below.

In some embodiments, carbon nanotube-infused fiber materials can be prepared in an “all-plasma” process. In such embodiments, the fiber materials pass through numerous plasma-mediated steps to form the final carbon nanotube-infused fiber materials. The first of the plasma processes, can include a step of fiber surface modification. This is a plasma process for “roughing” the surface of the fiber material to facilitate catalyst deposition, as described above. As also described above, surface modification can be achieved using a plasma of any one or more of a variety of different gases, including, without limitation, argon, helium, oxygen, ammonia, hydrogen, and nitrogen.

After surface modification, the fiber material proceeds to catalyst application. In the present all-plasma process, this step is a plasma process for depositing the carbon nanotube-forming catalyst on the fiber material. The carbon nanotube-forming catalyst is typically a transition metal as described above. The transition metal catalyst can be added to a plasma feedstock gas as a precursor in non-limiting forms including, for example, a ferrofluid, a metal organic, a metal salt, mixtures thereof or any other composition suitable for promoting gas phase transport. The carbon nanotube-forming catalyst can be applied at room temperature in ambient environment with neither vacuum nor an inert atmosphere being required. In some embodiments, the fiber material can be cooled prior to catalyst application.

Continuing the all-plasma process, carbon nanotube synthesis occurs in a carbon nanotube-growth reactor. Carbon nanotube growth can be achieved through the use of plasma-enhanced chemical vapor deposition, wherein carbon plasma is sprayed onto the catalyst-laden fibers. Since carbon nanotube growth occurs at elevated temperatures (typically in a range of about 500° C. to about 1000° C. depending on the catalyst), the catalyst-laden fibers can be heated prior to being exposed to the carbon plasma. For the carbon nanotube infusion process, the fiber material can be optionally heated until softening occurs. After heating, the fiber material is ready to receive the carbon plasma. The carbon plasma can be generated, for example, by passing a carbon-containing feedstock gas such as, for example, acetylene, ethylene, ethanol, and the like, through an electric field that is capable of ionizing the gas. This cold carbon plasma is directed, via spray nozzles, to the fiber material. The fiber material can be in close proximity to the spray nozzles, such as within about 1 centimeter of the spray nozzles, to receive the plasma. In some embodiments, heaters can be disposed above the fiber material at the plasma sprayers to maintain the elevated temperature of the fiber material.

Another configuration for continuous carbon nanotube synthesis involves a special rectangular reactor for the synthesis and growth of carbon nanotubes directly on fiber materials. The reactor can be designed for use in a continuous in-line process for producing carbon nanotube-infused fiber materials. In some embodiments, carbon nanotubes are grown via a CVD process at atmospheric pressure and an elevated temperature in the range of about 550° C. and about 800° C. in a multi-zone reactor. The fact that the carbon nanotube synthesis occurs at atmospheric pressure is one factor that facilitates the incorporation of the reactor into a continuous processing line for carbon nanotube infusion to the fiber materials. Another advantage consistent with in-line continuous processing using such a zone reactor is that carbon nanotube growth occurs in seconds, as opposed to minutes (or longer), as in other procedures and apparatus configurations typical in the art.

Carbon nanotube synthesis reactors in accordance with the various embodiments include the following features:

Rectangular Configured Synthesis Reactors: The cross-section of a typical carbon nanotube synthesis reactor known in the art is circular. There are a number of reasons for this including, for example, historical reasons (e.g., cylindrical reactors are often used in laboratories) and convenience (e.g., flow dynamics are easy to model in cylindrical reactors, heater systems readily accept circular tubes (e.g., quartz, etc.), and ease of manufacturing. Departing from the cylindrical convention, the present disclosure provides a carbon nanotube synthesis reactor having a rectangular cross section. The reasons for the departure include at least the following:

1) Inefficient Use of Reactor Volume. Since many fiber materials that can be processed by the reactor are relatively planar (e.g., flat tapes, sheet-like forms, or spread tows or rovings), a circular cross-section is an inefficient use of the reactor volume. This inefficiency results in several drawbacks for cylindrical carbon nanotube synthesis reactors including, for example, a) maintaining a sufficient system purge; increased reactor volume requires increased gas flow rates to maintain the same level of gas purge, resulting in inefficiencies for high volume production of carbon nanotubes in an open environment; b) increased carbon-containing feedstock gas flow rates; the relative increase in inert gas flow for system purge, as per a) above, requires increased carbon-containing feedstock gas flow rates. Consider that the volume of an illustrative 12K glass fiber roving is approximately 2000 times less than the total volume of a synthesis reactor having a rectangular cross-section. In an equivalent cylindrical reactor (i.e., a cylindrical reactor that has a width that accommodates the same planarized glass fiber material as the rectangular cross-section reactor), the volume of the glass fiber material is approximately 17,500 times less than the volume of the reactor. Although gas deposition processes, such as CVD, are typically governed by pressure and temperature alone, volume can have a significant impact on the efficiency of deposition. With a rectangular reactor there is a still excess volume, and this excess volume facilitates unwanted reactions. However, a cylindrical reactor has about eight times that volume available for facilitating unwanted reactions. Due to this greater opportunity for competing reactions to occur, the desired reactions effectively occur more slowly in a cylindrical reactor. Such a slow down in carbon nanotube growth, is problematic for the development of continuous growth processes. Another benefit of a rectangular reactor configuration is that the reactor volume can be decreased further still by using a small height for the rectangular chamber to make the volume ratio better and the reactions even more efficient. In some embodiments disclosed herein, the total volume of a rectangular synthesis reactor is no more than about 3000 times greater than the total volume of a fiber material being passed through the synthesis reactor. In some further embodiments, the total volume of the rectangular synthesis reactor is no more than about 4000 times greater than the total volume of the fiber material being passed through the synthesis reactor. In some still further embodiments, the total volume of the rectangular synthesis reactor is less than about 10,000 times greater than the total volume of the fiber material being passed through the synthesis reactor. Additionally, it is notable that when using a cylindrical reactor, more carbon-containing feedstock gas is required to provide the same flow percent as compared to reactors having a rectangular cross section. It should be appreciated that in some other embodiments, the synthesis reactor has a cross-section that is described by polygonal forms that are not rectangular, but are relatively similar thereto and provide a similar reduction in reactor volume relative to a reactor having a circular cross section; and c) problematic temperature distribution; when a relatively small-diameter reactor is used, the temperature gradient from the center of the chamber to the walls thereof is minimal, but with increased reactor size, such as would be used for commercial-scale production, such temperature gradients increase. Temperature gradients result in product quality variations across the fiber material (i.e., product quality varies as a function of radial position). This problem is substantially avoided when using a reactor having a rectangular cross-section. In particular, when a planar substrate is used, reactor height can be maintained constant as the size of the substrate scales upward. Temperature gradients between the top and bottom of the reactor are essentially negligible and, as a consequence, thermal issues and the product-quality variations that result are avoided.

2) Gas introduction. Because tubular furnaces are normally employed in the art, typical carbon nanotube synthesis reactors introduce gas at one end and draw it through the reactor to the other end. In some embodiments disclosed herein, gas can be introduced at the center of the reactor or within a target growth zone, symmetrically, either through the sides or through the top and bottom plates of the reactor. This improves the overall carbon nanotube growth rate because the incoming feedstock gas is continuously replenishing at the hottest portion of the system, which is where carbon nanotube growth is most active.

Zoning. Chambers that provide a relatively cool purge zone extend from both ends of the rectangular synthesis reactor. Applicants have determined that if a hot gas were to mix with the external environment (i.e., outside of the rectangular reactor), there would be increased degradation of the fiber material. The cool purge zones provide a buffer between the internal system and external environments. Carbon nanotube synthesis reactor configurations known in the art typically require that the substrate is carefully (and slowly) cooled. The cool purge zone at the exit of the present rectangular carbon nanotube growth reactor achieves the cooling in a short period of time, as required for continuous in-line processing.

Non-contact, hot-walled, metallic reactor. In some embodiments, a metallic hot-walled reactor (e.g., stainless steel) is employed. Use of this type of reactor can appear counterintuitive because metal, and stainless steel in particular, is more susceptible to carbon deposition (i.e., soot and by-product formation). Thus, most carbon nanotube synthesis reactors are made from quartz because there is less carbon deposited, quartz is easier to clean, and quartz facilitates sample observation. However, Applicants have observed that the increased soot and carbon deposition on stainless steel results in more consistent, efficient, faster, and stable carbon nanotube growth. Without being bound by theory it has been indicated that, in conjunction with atmospheric operation, the CVD process occurring in the reactor is diffusion limited. That is, the carbon nanotube-forming catalyst is “overfed;” too much carbon is available in the reactor system due to its relatively higher partial pressure (than if the reactor was operating under partial vacuum). As a consequence, in an open system—especially a clean one—too much carbon can adhere to the particles of carbon nanotube-forming catalyst, compromising their ability to synthesize carbon nanotubes. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, reacts with the carbon nanotube-forming catalyst at a rate that does not poison the catalyst. Existing systems run “cleanly” which, if they were open for continuous processing, would produce a much lower yield of carbon nanotubes at reduced growth rates.

Although it is generally beneficial to perform carbon nanotube synthesis “dirty” as described above, certain portions of the apparatus (e.g., gas manifolds and inlets) can nonetheless negatively impact the carbon nanotube growth process when soot creates blockages. In order to combat this problem, such areas of the carbon nanotube growth reaction chamber can be protected with soot inhibiting coatings such as, for example, silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones.

Combined Catalyst Reduction and Carbon Nanotube Synthesis. In the carbon nanotube synthesis reactor disclosed herein, both catalyst reduction and carbon nanotube growth occur within the reactor. This is significant because the reduction step cannot be accomplished timely enough for use in a continuous process if performed as a discrete operation. In a typical process known in the art, a reduction step typically takes 1-12 hours to perform. Both operations occur in a reactor in accordance with the present disclosure due, at least in part, to the fact that carbon-containing feedstock gas is introduced at the center of the reactor, not the end as would be typical in the art using cylindrical reactors. The reduction process occurs as the fiber material enters the heated zone. By this point, the gas has had time to react with the walls and cool off prior to reducing the catalyst (via hydrogen radical interactions). It is this transition region where the reduction occurs. At the hottest isothermal zone in the system, carbon nanotube growth occurs, with the greatest growth rate occurring proximal to the gas inlets near the center of the reactor.

In some embodiments, when loosely affiliated fiber materials including, for example, tows or rovings are employed (e.g., a glass roving), the continuous process can include steps that spread out the strands and/or filaments of the tow or roving. Thus, as a tow or roving is unspooled it can be spread using a vacuum-based fiber spreading system, for example. When employing sized glass fiber rovings, for example, which can be relatively stiff, additional heating can be employed in order to “soften” the roving to facilitate fiber spreading. The spread fibers which contain individual filaments can be spread apart sufficiently to expose an entire surface area of the filaments, thus allowing the roving to more efficiently react in subsequent process steps. For example, a spread tow or roving can pass through a surface treatment step that is composed of a plasma system as described above. The roughened, spread fibers then can pass through a carbon nanotube-forming catalyst dip bath. The result is fibers of the glass roving that have catalyst particles distributed radially on their surface. The catalyzed-laden fibers of the roving then enter an appropriate carbon nanotube growth chamber, such as the rectangular chamber described above, where a flow through atmospheric pressure CVD or plasma enhanced-CVD process is used to synthesize carbon nanotubes at rates as high as several microns per second. The fibers of the roving, now having radially aligned carbon nanotubes, exit the carbon nanotube growth reactor.

It is to be understood that modifications which do not substantially affect the activity of the various embodiments of this invention are also included within the definition of the invention provided herein. Although the invention has been described with reference to the disclosed embodiments, those of ordinary skill in the art will readily appreciate that these only illustrative of the invention. It should be understood that various modifications can be made without departing from the spirit of the invention, which is defined by the following claims.

What is claimed is:

1. A filtration system comprising:
a filtration medium comprising a plurality of fibers of spoolable length that comprise a carbon nanotube-infused fiber material.

2. The filtration system of claim 1, wherein the plurality of fibers comprise a form selected from the group consisting of yarns, fiber tows, tapes, braids, woven fabrics, non-woven fabrics, fiber plies, and fiber mats.

3. The filtration system of claim 1, further comprising:
at least one dip roller and at least one alignment roller.

4. The filtration system of claim 1, further comprising:
a reel-to-reel processing system comprising a first reel and a second reel;
wherein the filtration medium is transported from the first reel to the second reel.

5. The filtration system of claim 1, wherein the filtration medium comprises a closed loop structure that is continuously transported over a plurality of rollers.

6. The filtration system of claim 1, further comprising:
at least one press roller through which the filtration medium is transported.

7. The filtration system of claim 6, further comprising:
at least one collection device that is operable for sequestering any liquids removed from the filtration medium at the at least one press roller.

8. The filtration system of claim 6, further comprising:
at least one chemical extraction bath through which the filtration medium is transported.

9. The filtration system of claim 8, further comprising:
at least one collection device that is operable for sequestering any liquids removed from the filtration medium at the at least one press roller.

10. The filtration system of claim 1, further comprising:
at least one chemical extraction bath through which the filtration medium is transported.

11. A filtration system comprising:
a reel-to-reel processing system comprising a first reel and a second reel;
a filtration medium connected to the reel-to-reel processing system;
wherein the filtration medium comprises a plurality of fibers of continuous length that comprise a carbon nanotube-infused fiber material;
at least one alignment roller and at least one dip roller against which the filtration medium is tensioned; and
at least one press roller through which the filtration medium is transported.

12. The filtration system of claim 11, wherein the plurality of fibers comprise a form selected from the group consisting of yarns, fiber tows, tapes, braids, woven fabrics, non-woven fabrics, fiber plies, and fiber mats.

13. The filtration system of claim 11, further comprising:
at least one collection device that is operable for sequestering any liquids removed from the filtration medium at the at least one press roller.

14. The filtration system of claim 11, further comprising:
at least one chemical extraction bath through which the filtration medium is transported.

15. The filtration system of claim 14, further comprising:
at least one collection device that is operable for sequestering any liquids removed from the filtration medium at the at least one press roller.

16. A method comprising:
providing a filtration medium comprising a plurality of fibers of spoolable length that comprise a carbon nanotube-infused fiber material;
transporting the filtration medium through a liquid medium comprising a hydrophobic material;
sorbing at least a portion of the hydrophobic material from the liquid medium onto the filtration medium; and
after sorbing the hydrophobic material, transporting the filtration medium through at least one press roller.

17. The method of claim 16, further comprising:
sequestering any hydrophobic material removed at the at least one press roller in a collection device.

18. The method of claim 16, wherein the plurality of fibers comprise a form selected from the group consisting of yarns, fiber tows, tapes, braids, woven fabrics, non-woven fabrics, fiber plies, and fiber mats.

19. The method of claim 16, wherein transporting the filtration medium through a liquid medium comprises passing the filtration medium over at least one alignment roller and at least one dip roller.

20. The method of claim 16, wherein the filtration medium is transported in a reel-to-reel processing system between a first reel and a second reel.

21. The method of claim 16, wherein the filtration medium comprises a closed loop structure that is continuously transported over a plurality of rollers.

22. The method of claim 16, further comprising:
after sorbing the hydrophobic material, transporting the filtration medium through at least one chemical extraction bath.

23. The method of claim 22, further comprising:
sequestering any hydrophobic material removed at the at least one press roller in a collection device.

24. The method of claim 16, wherein the liquid medium comprises an aqueous phase containing an admixed hydrophobic material.

25. The method of claim 24, wherein the admixed hydrophobic material comprises oil.

26. The method of claim 16, wherein the liquid medium comprises a bilayer.

27. The method of claim 26, wherein the bilayer comprises an oil-water bilayer.

28. The method of claim 16, wherein the liquid medium comprises oil in a subterranean formation.

29. The method of claim 16, wherein the liquid medium comprises a water source containing trace organic pollutants.

30. The method of claim 16, wherein the liquid medium comprises a fermentation broth.

31. A method comprising:
providing a filtration medium comprising a plurality of fibers of spoolable length that comprise a carbon nanotube-infused fiber material that is connected to a reel-to-reel processing system comprising a first reel and a second reel;
transporting the filtration medium through a liquid medium comprising a hydrophobic material;
sorbing at least a portion of the hydrophobic material from the liquid medium onto the filtration medium;
after sorbing the hydrophobic material, transporting the filtration medium through at least one press roller; and
sequestering any hydrophobic material removed at the at least one press roller in a collection device.

32. The method of claim 31, further comprising:
after sorbing the hydrophobic material, transporting the filtration medium through at least one chemical extraction bath.

33. The method of claim 31, wherein the plurality of fibers comprise a form selected from the group consisting of yarns, fiber tows, tapes, braids, woven fabrics, non-woven fabrics, fiber plies, and fiber mats.

34. The method of claim 31, wherein transporting the filtration medium through a liquid medium comprises passing the filtration medium over at least one alignment roller and at least one dip roller.

35. A method comprising:
providing a filtration medium comprising a plurality of fibers of spoolable length that comprise a carbon nanotube-infused fiber material;
transporting the filtration medium through a liquid medium comprising a trace hydrophobic compound;
sorbing at least a portion of the trace hydrophobic compound from the liquid medium onto the filtration medium; and
isolating the trace hydrophobic compound from the filtration medium.
